(19) United States
(12) Patent Application Publication
(10) Pub. No.: US 2025/0377937 A1
(43) Pub. Date: Dec. 11, 2025

(54) GRAPHICS MEMORY REUSE METHODS AND APPARATUSES BASED ON GPU MULTISTREAM CONCURRENCY

(71) Applicant: Alipay (Hangzhou) Information Technology Co., Ltd., Hangzhou (CN)

(72) Inventors: Rui Zhang, Hangzhou (CN); Junping Zhao, Hangzhou (CN); Jiale Xu, Hangzhou (CN)

(73) Assignee: Alipay (Hangzhou) Information Technology Co., Ltd., Hangzhou (CN)

(21) Appl. No.: 18/962,945

(22) Filed: Nov. 27, 2024

(30) Foreign Application Priority Data
Jun. 7, 2024 (CN) 202410743233.4

(51) Int. Cl. G06F 9/50

(52) U.S. Cl. CPC G06F 9/5016; G06F 9/5022

(57) ABSTRACT

Embodiments of this specification provide graphics memory reuse methods and apparatuses based on GPU multistream concurrency. In an implementation of a default stream reuse mode, a method includes determining, based on (1) a released graphics memory corresponding to a current GPU stream that comprises a GPU instruction to which a graphics memory is to be allocated and (2) whether the current GPU stream is a default stream, whether a candidate reusable graphics memory block exists in a graphics memory pool for storing a released graphics memory block. If the candidate reusable graphics memory block exists, determining, from the candidate reusable graphics memory block, a graphics memory block to be allocated to the GPU instruction.

### CROSS-REFERENCE TO RELATED APPLICATIONS

This application claims priority to Chinese Patent Application No. 202410743233.4, filed on Jun. 7, 2024, which is hereby incorporated by reference in its entirety.

### TECHNICAL FIELD

Embodiments of this specification usually relate to the field of computer technologies, and in particular, to graphics memory reuse methods and apparatuses based on GPU multistream concurrency.

### BACKGROUND

Graphics processing units (GPU) are acceleration hardware that can be used for graphics display, computing acceleration (for example, deep learning), etc. The GPUs are featured by high-speed parallel computing, and are applicable for cooperation with a central processing unit (CPU) to form a CPU+GPU heterogeneous computing architecture, so that a parallel task can be efficiently processed. As high-speed memory mediums on the GPUs, graphics memories usually have very high bandwidths (up to 3000 GB+/sec) but have relatively small capacities (for example, 24 GB to 96 GB), and the capacities of the graphics memories directly restrict some large-scale computing tasks, for example, deep learning tasks related to large models and large samples. Therefore, in tasks related to GPU multistream concurrency, how to make full use of a graphics memory occupied by each GPU stream is of great significance for improving usage efficiency of the graphics memory, implementing large-scale computing, etc.

### SUMMARY

In view of the above-mentioned descriptions, embodiments of this specification provide graphics memory reuse methods and apparatuses based on GPU multistream concurrency. According to the methods and the apparatuses, graphics memory resources can be reused securely and efficiently.

According to an aspect of one or more embodiments of this specification, a graphics memory reuse method based on GPU multistream concurrency is provided. At least two GPU streams are concurrently executed, each GPU stream includes GPU instructions arranged in an execution sequence, and the graphics memory reuse method includes: in a default stream reuse mode, determining, based on a released graphics memory corresponding to a current GPU stream including a GPU instruction to which a graphics memory is to be allocated and whether the current GPU stream is a default stream, whether a candidate reusable graphics memory block exists in a graphics memory pool used to store a released graphics memory block; and if the candidate reusable graphics memory block exists, determining, from the candidate reusable graphics memory block, a graphics memory block to be allocated to the GPU instruction to which a graphics memory is to be allocated.

According to another aspect of the embodiments of this specification, a graphics memory reuse apparatus based on GPU multistream concurrency is provided. At least two GPU streams are concurrently executed, each GPU stream includes GPU instructions arranged in an execution sequence, and the graphics memory reuse apparatus includes: a candidate graphics memory block determining unit, configured to: in a default stream reuse mode, determine, based on a released graphics memory corresponding to a current GPU stream including a GPU instruction to which a graphics memory is to be allocated and whether the current GPU stream is a default stream, whether a candidate reusable graphics memory block exists in a graphics memory pool used to store a released graphics memory block; and a graphics memory allocation unit, configured to: if the candidate reusable graphics memory block exists, determine, from the candidate reusable graphics memory block, a graphics memory block to be allocated to the GPU instruction to which a graphics memory is to be allocated.

According to still another aspect of the embodiments of this specification, a graphics memory reuse apparatus based on GPU multistream concurrency, including: an analysis configuration unit, configured to determine a current stream reuse mode; a policy selection unit, configured to: determine a corresponding graphics memory reuse policy based on the current stream reuse mode; and determine, based on the determined graphics memory reuse policy, a graphics memory block to be allocated to a GPU instruction to which a graphics memory is to be allocated; a graphics memory management unit, configured to perform a graphics memory allocation or graphics memory release operation; and a graphics memory state updating unit, configured to update a state of a graphics memory block after the graphics memory block is allocated or released.

According to still another aspect of the embodiments of this specification, a graphics memory reuse apparatus based on GPU multistream concurrency is provided, including: at least one processor, and a storage coupled to the at least one processor. The storage stores instructions, and when the instructions are executed by the at least one processor, the at one processor is enabled to perform the above-mentioned graphics memory reuse method based on GPU multistream concurrency.

According to yet another aspect of the embodiments of this specification, a computer-readable storage medium is provided. The computer-readable storage medium stores a computer program, and when the computer program is executed by a processor, the above-mentioned graphics memory reuse method based on GPU multistream concurrency is implemented.

According to yet another aspect of the embodiments of this specification, a computer program product is provided, including a computer program. The computer program is executed by a processor to implement the above-mentioned graphics memory reuse method based on GPU multistream concurrency.

### BRIEF DESCRIPTION OF DRAWINGS

The essence and advantages of the content of this specification can be further understood by referring to the following accompanying drawings. In the accompanying drawings, similar components or features can have the same reference numerals.

FIG. 1 shows an example architecture of a graphics memory reuse method and apparatus based on GPU multistream concurrency, according to embodiments of this specification;

FIG. 2 is a schematic diagram illustrating an example of GPU multistream concurrency, according to one or more embodiments of this specification;

FIG. 3 is a schematic diagram illustrating an example of a released graphics memory corresponding to concurrent GPU streams, according to one or more embodiments of this specification;

FIG. 4 is a flowchart illustrating an example of a graphics memory reuse method based on GPU multistream concurrency, according to one or more embodiments of this specification;

FIG. 5 is a flowchart illustrating an example of a process of determining whether a candidate reusable graphics memory block exists in a graphics memory pool, according to one or more embodiments of this specification;

FIG. 6 is a flowchart illustrating another example of a process of determining whether a candidate reusable graphics memory block exists in a graphics memory pool, according to one or more embodiments of this specification;

FIG. 7 is a flowchart illustrating still another example of a process of determining whether a candidate reusable graphics memory block exists in a graphics memory pool, according to one or more embodiments of this specification;

FIG. 8 is a schematic diagram illustrating an example of a graphics memory allocation process, according to one or more embodiments of this specification;

FIG. 9 is a schematic diagram illustrating another example of a graphics memory allocation process, according to one or more embodiments of this specification;

FIG. 10 is a block diagram illustrating an example of a graphics memory reuse apparatus based on GPU multistream concurrency, according to one or more embodiments of this specification;

FIG. 11 is a block diagram illustrating an example of a candidate determining unit in a graphics memory reuse apparatus based on GPU multistream concurrency, according to one or more embodiments of this specification; and

FIG. 12 is a schematic diagram illustrating an example of a graphics memory reuse apparatus based on GPU multistream concurrency, according to one or more embodiments of this specification.

### DESCRIPTION OF EMBODIMENTS

The subject matter described here will be discussed below with reference to example implementations. It should be understood that these implementations are merely discussed to enable a person skilled in the art to better understand and implement the subject matter described in this specification, and are not intended to limit the protection scope, applicability, or examples described in the claims. The functions and arrangements of the elements under discussion can be changed without departing from the protection scope of the embodiment content of this specification. Various processes or components can be omitted, replaced, or added in the examples as needed. In addition, features described for some examples can also be combined in other examples.

As used in this specification, the term “include” and its variant represents open terms, meaning “including but not limited to”. The term “based on” means “at least partially based on”. The terms “one embodiment” and “one or more embodiments” represent “at least one embodiment”. The term “another embodiment” means “at least one other embodiment”. The terms “first”, “second”, etc. can refer to different or identical objects. Other definitions, whether explicit or implicit, can be included below. Unless expressly specified in the context, the definition of a term is consistent throughout this specification.

In this specification, the term “GPU multistream concurrency” can be a technology in which parallelism and task scheduling can be implemented in GPU programming. The stream can be considered as an independent instruction queue, and GPU instructions in this queue are executed in sequence, but can be concurrently executed with a GPU instruction in another stream. In programming models such as a compute unified device architecture (CUDA), the stream can be used to efficiently organize concurrently executed workloads on GPUs to optimize performance. For example, in a deep learning task, different streams can concurrently execute different operators, so that the operators (communication, computing, etc.) can be concurrently executed, and use efficiency of a GPU is improved.

In this specification, the term “computational graph” is a directed graph for representing and computing various operations of a neural network. A node in the computational graph represents an operation, and an edge represents a flow of data (for example, a tensor) between operations. The computational graph is a method for describing and optimizing the neural network in a deep learning framework.

In this specification, the term “operators” is a function or method for implementing a specific operation described in the node in the computational graph. In the deep learning framework, the operator defines how to perform a specific operation or transformation on input data. For example, one operator can be a matrix multiplication operation, and another operator can be a rectified linear unit (ReLU) activation function.

In this specification, the term “graphics memory pool” can be used to carry a software container carrying an allocated and currently released graphics memory address. In a graphics memory pool technology, a graphics memory address obtained through application is cached, to effectively reduce a quantity of times of invoking a graphics memory allocation function in an underlying hardware driver, and improve an allocation speed and use efficiency of graphics memory resources.

The following describes in detail a graphics memory reuse method and apparatus based on GPU multistream concurrency according to the embodiments of this specification with reference to the accompanying drawings.

FIG. 1 shows an example architecture 100 of a graphics memory reuse method and apparatus based on GPU multistream concurrency, according to embodiments of this specification.

In FIG. 1, a network 110 is applied to interconnection between a terminal device 120 and an application server 130.

The network 110 can be any type of network that can mutually interconnect network entities. The network 110 can be a single network or a combination of various networks. In terms of a coverage area, the network 110 can be a local area network (LAN), a wide area network (WAN), etc. In terms of a bearing medium, the network 110 can be a wired network, a wireless network, etc. In terms of a data exchange technology, the network 110 can be a circuit switching network, a packet switching network, etc.

The terminal device 120 can be any type of electronic computing device that can be connected to the network 110, access a server or website on the network 110, process data or signals, etc. For example, the terminal device 120 can be a desktop computer, a laptop computer, a tablet computer, a smartphone, etc. Although only one terminal device is shown in FIG. 1, it should be understood that different quantities of terminal devices can be connected to the network 110.

In an implementation, the terminal device 120 can be used by a user. The terminal device 120 can include an application client device (for example, an application client device 121) that provides various services for a user. In some cases, the application client device 121 can interact with the application server 130. For example, the application client device 121 can transmit a message entered by the user to the application server 130, and receive, from the application server 130, a response associated with the message. However, it should be understood that in this specification, “message” can be any input information, for example, a computing task from a user input.

The application server 130 can efficiently execute the computing task based on a CPU+GPU heterogeneous computing architecture. In some examples, first, data needed for the computing task are sent from a CPU memory to a GPU memory. A GPU performs parallel computing through a plurality of GPU streams based on an instruction of a CPU, and then transfers a computing result back to the CPU memory. In this process, a data copy operation between the CPU and the GPU and a computing operation of the GPU can be performed concurrently, to improve efficiency.

It should be understood that all network entities shown in FIG. 1 are examples. The architecture 100 can involve any other network entity based on a specific application need.

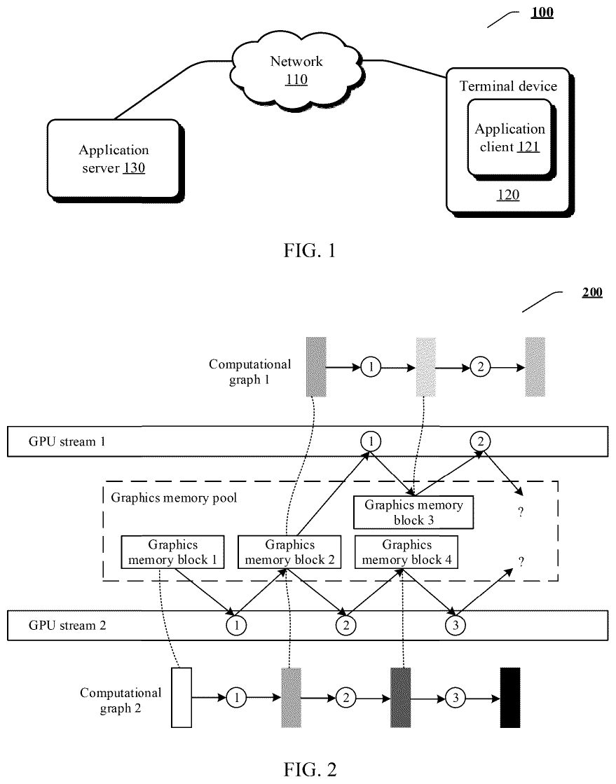

FIG. 2 is a schematic diagram illustrating an example of GPU multistream concurrency 200, according to one or more embodiments of this specification. In the one or more embodiments, one GPU computing task can be jointly completed through at least two concurrently executed GPU streams (for example, a GPU stream 1 and a GPU stream 2 shown in FIG. 2). Each GPU stream can include GPU instructions arranged in an execution sequence. As shown in FIG. 2, currently, the GPU stream 1 can include two GPU instructions (for example, an operator in a computational graph), and the GPU stream 2 can include three GPU instructions. The GPU instructions in the GPU stream 1 and the GPU instructions in the GPU stream 2 can be concurrently executed. However, the GPU instructions in the GPU stream 1 and the GPU instructions in the GPU stream 2 are executed successively based on a sequence in which the GPU instructions are arranged in the streams including the GPU instructions. As the GPU computing task progresses, a corresponding graphics memory can be allocated in advance to a to-be-executed GPU instruction for use in computing.

In the CPU+GPU heterogeneous computing architecture in which a concept of a graphics memory pool is introduced, corresponding graphics memory resources can be allocated to all GPU instructions. The graphics memory pool can be configured to store a released graphics memory resource. In an example, the graphics memory pool can be maintained by a CUDA driver program. For example, when cudaFree is invoked, it means that corresponding graphics memory resources are released. In some examples, a released graphics memory can be used to indicate a total quantity of released graphics memories. In some examples, the released graphics memory can also be used to indicate information about each released graphics block, for example, a start address and a capacity. In some examples, the information about each released graphics memory block can be arranged in a sequence of corresponding GPU instructions in a GPU stream. It can be understood that an actual execution process on the GPU may still not be ended after a graphics memory resource is released from a perspective of a CPU because of a relatively fast execution speed of the CPU. In an example, as shown in FIG. 2, the graphics memory pool can include a released graphics memory block 1 to a released graphics memory block 4. The graphics memory block 1 can be configured to store data to which the first GPU instruction in the GPU stream 2 is specific. A graphics memory block 2 can be configured to store an execution result of the first GPU instruction in the GPU stream 2. In this example, the execution result can be used as both data to which the first GPU instruction in the GPU stream 1 is specific and data to which the second GPU instruction in the GPU stream 2 is specific. A graphics memory block 3 can be configured to store an execution result of the first GPU instruction in the GPU stream 1. The graphics memory block 4 can be configured to store an execution result of the second GPU instruction in the GPU stream 2. Further, a graphics memory can continue to be allocated to the second GPU instruction in the GPU stream 1 and the third GPU instruction in the GPU stream 2.

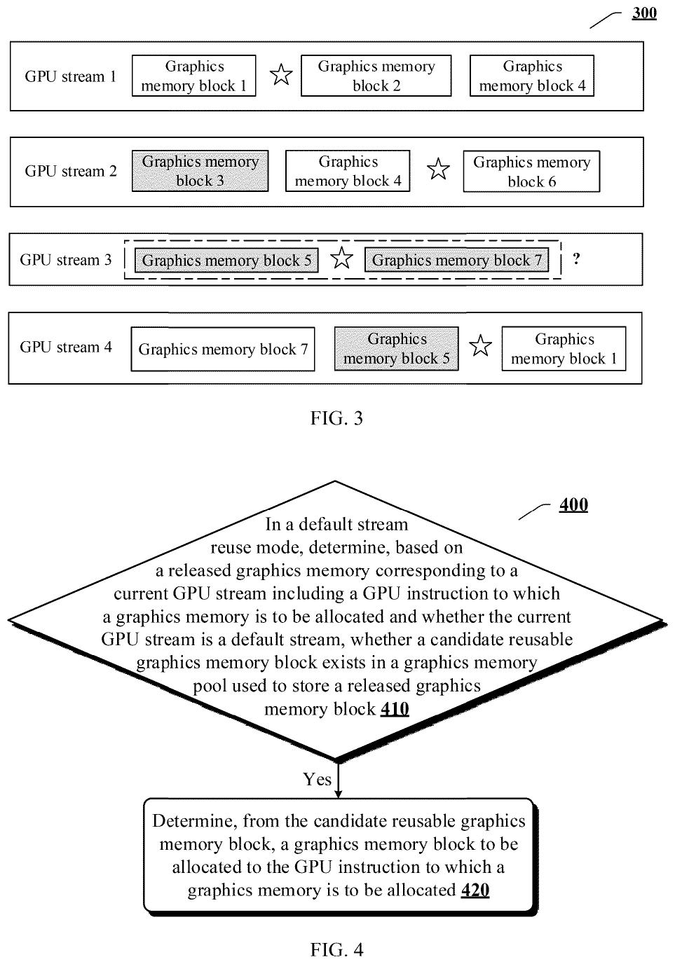

In some examples, the released graphics memory can also be represented by the information that is about the released graphics blocks and that is arranged in sequence. An arrangement sequence of the information about the graphics memory block is consistent with an arrangement sequence of a corresponding GPU instruction in the GPU stream. FIG. 3 is a schematic diagram illustrating an example of a released graphics memory 300 corresponding to concurrent GPU streams, according to one or more embodiments of this specification. As shown in FIG. 3, a location of a ⋆ in each GPU stream can represent a location, in the entire GPU stream, of a GPU instruction currently executed in the GPU stream. A location of? in the GPU stream can represent a location, in the entire GPU stream, of a GPU instruction to which a graphics memory needs to be allocated in the GPU stream.

FIG. 4 is a flowchart illustrating an example of a graphics memory reuse method 400 based on GPU multistream concurrency, according to one or more embodiments of this specification.

As shown in FIG. 4, in 410, in a default stream reuse mode, determine, based on a released graphics memory corresponding to a current GPU stream including a GPU instruction to which a graphics memory is to be allocated and whether the current GPU stream is a default stream, whether a candidate reusable graphics memory block exists in a graphics memory pool used to store a released graphics memory block.

In the one or more embodiments, the default stream reuse mode can be pre-specified as a GPU stream of the default stream. The default stream reuse mode can be used to indicate that only another GPU stream is allowed to reuse a graphics memory resource allocated to the default stream, but the default stream is not allowed to reuse a graphics memory resource allocated to the another GPU stream. In some examples, a user can pre-specify to use the default stream reuse mode, and can also specify an identifier of a GPU stream that serves as the default stream. In some examples, a used stream reuse mode can be determined based on a distribution of allocated graphics memories respectively corresponding to all the concurrently executed GPU streams. In some examples, if a GPU stream (for example, a GPU stream whose allocated graphics memory resources account for more than 70% of allocated graphics memory resources of all the GPU streams) that significantly occupies the majority of graphics memory resources exists in the at least two concurrently executed GPU streams, it can be determined that the default stream reuse mode is to be used, and the GPU stream that significantly occupies the majority of the graphics memory resources can be determined as the default stream.

In the one or more embodiments, the GPU instruction to which a graphics memory is to be allocated can correspond to a graphics memory capacity need, for example, 4 MB, 16 MB, or 128 MB. In an example, as shown in FIG. 2, if a graphics memory needs to be allocated to the second GPU instruction in a GPU stream 1, the current GPU stream including the GPU instruction to which a graphics memory is to be allocated can be the stream 1. In this case, whether a candidate reusable graphics memory block exists in the graphics memory pool used to store the released graphics memory block can be determined based on a released graphics memory corresponding to the GPU stream 1 and whether the GPU stream 1 is a default stream. Similarly, if a graphics memory needs to be allocated to the third GPU instruction in a GPU stream 2, the current GPU stream including the GPU instruction to which a graphics memory is to be allocated can be the stream 2. In this case, whether a candidate reusable graphics memory block exists in the graphics memory pool used to store the released graphics memory block can be determined based on a released graphics memory corresponding to the GPU stream 2 and whether the GPU stream 2 is a default stream.

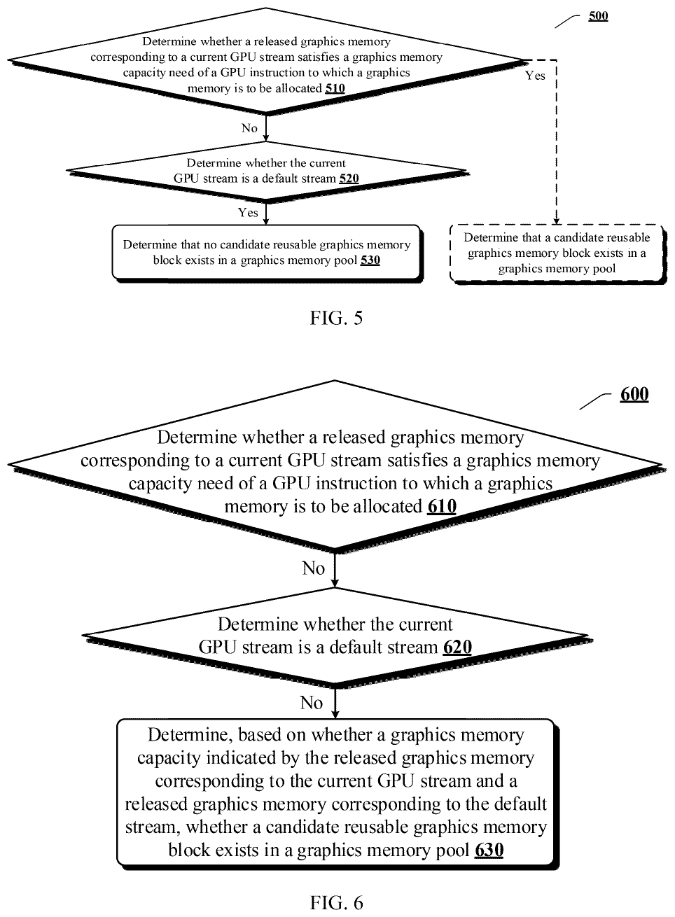

FIG. 5 is a flowchart illustrating an example of a process 500 of determining whether a candidate reusable graphics memory block exists in a graphics memory pool, according to one or more embodiments of this specification.

As shown in FIG. 5, in 510, whether a released graphics memory corresponding to a current GPU stream satisfies a graphics memory capacity need of a GPU instruction to which a graphics memory is to be allocated.

In the one or more embodiments, whether a capacity of all released graphics memory blocks corresponding to the current GPU stream is not less than the graphics memory capacity need of the GPU instruction to which a graphics memory is to be allocated can be determined. In some examples, whether a capacity of a graphics memory block obtained by unifying all released graphics memory blocks corresponding to the current GPU stream is not less than the graphics memory capacity need can be determined. In some examples, graphics memory blocks whose physical addresses are connected or graphics memory blocks whose physical addresses can be mapped to connectable virtual address through CUDA virtual address management can be directly concatenated. In an example, as shown in FIG. 3, a released graphics memory corresponding to a GPU stream 3 of the current GPU stream can include a graphics memory block 5 and a graphics memory block 7. Whether a capacity of the graphics memory block 5 or a capacity of the graphics memory block 7 satisfies the graphics memory capacity need. In some examples, if an address of the graphics memory block 5 and an address of the graphics memory block 7 are consecutive, whether the sum of the capacity of the graphics memory block 5 and the capacity of the graphics memory block 7 satisfies the graphics memory capacity need can be determined. It can be understood that when another GPU stream serves as the current GPU stream, whether a capacity of a released graphics memory and corresponding to the GPU stream satisfies the corresponding graphics memory capacity need can also be determined.

If a determination of 510 is no, 520 and 530 are performed.

In 520, whether the current GPU stream is a default stream is determined.

If a determination of 520 is yes, in 530, it is determined that no candidate reusable graphics memory block exists in the graphics memory pool.

In some examples, if a determination of 510 is yes, it is determined that a candidate reusable graphics memory block exists in the graphics memory pool.

FIG. 6 is a flowchart illustrating another example of a process 600 of determining whether a candidate reusable graphics memory block exists in a graphics memory pool, according to one or more embodiments of this specification.

As shown in FIG. 6, in 610, whether a released graphics memory corresponding to a current GPU stream satisfies a graphics memory capacity need of a GPU instruction to which a graphics memory is to be allocated.

If a determination of 610 is no, 620 and 630 are performed.

In 620, whether the current GPU stream is a default stream is determined.

For operations of 610 and 620, references can be made to related descriptions of 510 and 520 in the one or more embodiments of FIG. 5. Details are omitted here for simplicity.

If a determination of 620 is no, in 630, whether a candidate reusable graphics memory block exists in the graphics memory pool is determined based on whether a graphics memory capacity indicated by a released graphics memory corresponding to the current GPU stream and a released graphics memory corresponding to the default stream satisfies the corresponding graphics memory capacity need.

In some examples, if a total graphics memory capacity indicated by the released graphics memory corresponding to the current GPU stream and the released graphics memory corresponding to the default stream satisfies the corresponding graphics memory capacity need, it can be determined that a candidate reusable graphics memory block exists in the graphics memory pool. If a total graphics memory capacity indicated by the released graphics memory corresponding to the current GPU stream and the released graphics memory corresponding to the default stream does not satisfy the corresponding graphics memory capacity need, it can be determined that no candidate reusable graphics memory block exists in the graphics memory pool.

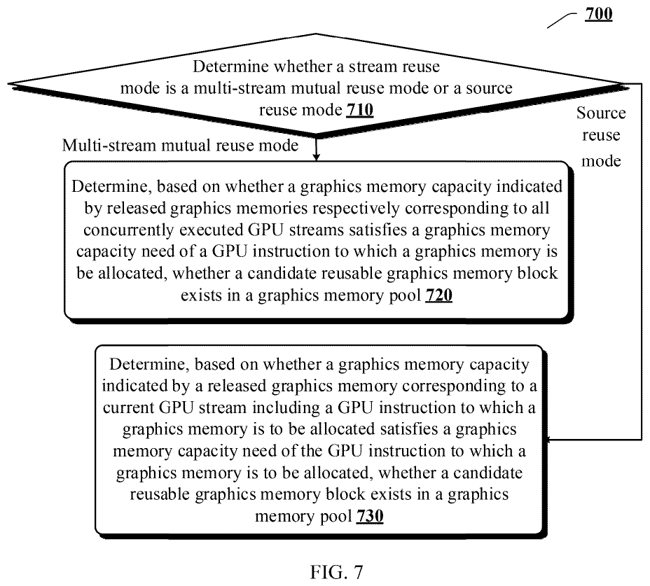

FIG. 7 is a flowchart illustrating still another example of a process 700 of determining whether a candidate reusable graphics memory block exists in a graphics memory pool, according to one or more embodiments of this specification.

As shown in FIG. 7, in 710, whether a stream reuse mode is a multi-stream mutual reuse mode or a source reuse mode is determined.

In the one or more embodiments, whether the multi-stream mutual reuse mode or the source reuse mode is used can be determined based on the stream reuse mode pre-specified by the user. The multi-stream mutual reuse mode can be used to indicate that any GPU stream is allowed to reuse a graphics memory resource allocated to another GPU stream. The source reuse mode can be used to indicate that a GPU stream is only allowed to reuse a graphics memory resource allocated to the GPU stream, but is not allowed to reuse a graphics memory resource allocated to another default stream.

In some examples, whether the stream reuse mode is the multi-stream mutual reuse mode can be determined based on a distribution of allocated graphics memories respectively corresponding to all concurrently executed GPU streams. In some examples, if no GPU stream (for example, a GPU stream whose allocated graphics memory resources account for more than 70% of allocated graphics memory resources of all the GPU streams) that significantly occupies the majority of graphics memory resources exists in the at least two concurrently executed GPU streams, it can be determined that the stream reuse mode is the multi-stream mutual reuse mode.

According to the above-mentioned manner, in this solution, a proper stream reuse mode can be selected automatically based on different distributions of graphics memory resources, and a stream reuse mode selection solution applicable to a scenario in which a plurality of GPU streams are simultaneously enabled to separately run different models, a scenario in which a plurality of GPU stream are simultaneously enabled to separately run the same operation is creatively proposed, so that a graphics memory is reused securely and efficiently.

If a determination of 710 is multi-stream mutual reuse mode, in 720, whether a candidate reusable graphics memory block exists in the graphics memory pool is determined based on whether a graphics memory capacity indicated by released graphics memories respectively corresponding to all concurrently executed GPU streams satisfies a graphics memory capacity need of the GPU instruction to which a graphics memory is to be allocated.

In the one or more embodiments, if the total graphics memory capacity indicated by the released graphics memories respectively corresponding to all the concurrently executed GPU streams satisfies the graphics memory capacity need of the GPU instruction to which a graphics memory is to be allocated, it can be determined that a candidate reusable graphics memory block exists in the graphics memory pool. If the total graphics memory capacity indicated by the released graphics memories respectively corresponding to all the concurrently executed GPU streams does not satisfy the graphics memory capacity need of the GPU instruction to which a graphics memory is to be allocated, it can be determined that no candidate reusable graphics memory block exist in the graphics memory pool.

If a determination of 710 is the source reuse mode, in 730, whether a candidate reusable graphics memory block exists in the graphics memory pool is determined based on whether a graphics memory capacity indicated by the released graphics memory corresponding to the current GPU stream including the GPU instruction to which a graphics memory is to be allocated satisfies a graphics memory capacity need of the GPU instruction to which a graphics memory is to be allocated.

In the one or more embodiments, if the graphics memory capacity indicated by the released graphics memory corresponding to the current GPU stream including the GPU instruction to which a graphics memory is to be allocated satisfies the graphics memory capacity need of the GPU instruction to which a graphics memory is to be allocated, it can be determined that a candidate reusable graphics memory block exists in the graphics memory pool. If the graphics memory capacity indicated by the released graphics memory corresponding to the current GPU stream including the GPU instruction to which a graphics memory is to be allocated does not satisfy the graphics memory capacity need of the GPU instruction to which a graphics memory is to be allocated, it can be determined that no candidate reusable graphics memory block exists in the graphics memory pool.

In the above-mentioned manner, this solution provides a solution in which whether a candidate reusable graphics memory block exists in the graphics memory pool is determined with reference to the stream reuse mode and the released graphics memories respectively corresponding to all the GPU streams.

Back to FIG. 4. In 420, if a candidate reusable graphics memory block exists, a graphics memory block to be allocated to the GPU instruction to which a graphics memory is to be allocated is determined from the candidate reusable graphics memory block.

In the one or more embodiments, the graphics memory block to be allocated to the GPU instruction to which a graphics memory is to be allocated can be determined from the candidate reusable graphics memory block in various manners, so that the GPU instruction can be securely reused to provide a graphics memory block with enough graphics memory resources.

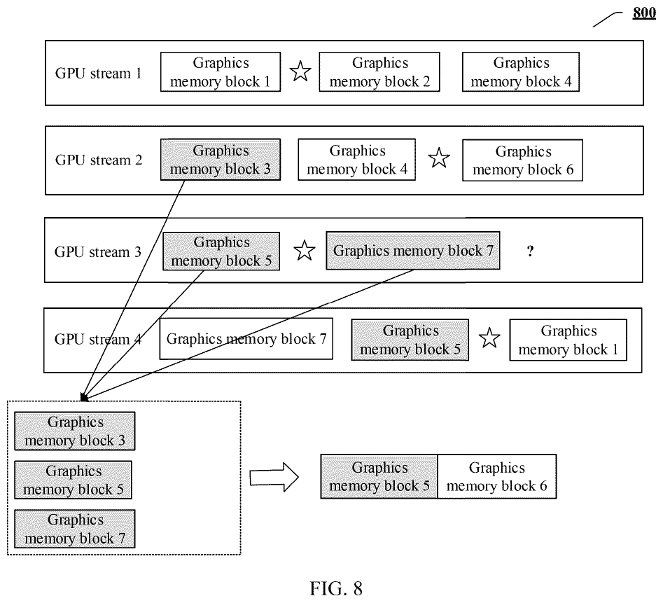

FIG. 8 is a schematic diagram illustrating an example of a graphics memory allocation process 800, according to one or more embodiments of this specification.

As shown in FIG. 8, the released graphics memories corresponding to all the GPU streams can be arranged in a release sequence (which is consistent with the execution sequence of corresponding instructions in the GPU streams). Each graphics memory block in the graphics memory pool can have a reusable state flag. The reusable state flag can be used to indicate whether the graphics memory block can be securely reused currently. It can be understood that the graphics memory block can be reused at different times in different GPU streams. In an example, for each graphics memory block, a corresponding GPU instruction use sequence can exist. Each graphics memory block is first allocated to a GPU stream including the first GPU instruction in a corresponding GPU instruction use sequence. In an example, when all GPU instructions in the GPU instruction use sequence corresponding to the graphics memory block are executed, the reusable state flag of the graphics memory block can be used to indicate that the graphics memory block is currently in a reusable state. In an example, when all GPU instructions other than the current GPU stream in the GPU instruction use sequence corresponding to the graphics memory block are executed, the reusable state flag of the graphics memory block can be used to indicate that the graphics memory block is currently in a reusable state. In an example, as shown in FIG. 8, the graphics memory pool can include a released graphics memory block 1 to a released graphics memory block 7. Reusable state flags of a graphics memory block 3, a graphics memory block 5, and the graphics memory block 7 are used to indicate that the graphics memory block 3, the graphics memory block 5, and the graphics memory block 7 are currently in a reusable state, and reusable state flags of the graphics memory block 1, a graphics memory block 2, a graphics memory block 4, and a graphics memory block 6 are used to indicate that the graphics memory block 1, the graphics memory block 2, the graphics memory block 4, and the graphics memory block 6 are currently in a non-reusable state.

In the one or more embodiments, it is assumed that the candidate reusable graphics memory block is the graphics memory block 1 to the graphics memory block 7. A first candidate graphics memory block, namely, the graphics memory block 3, the graphics memory block 5, and the graphics memory block 7, can be determined from the graphics memory block 1 to the graphics memory block 7. In an example, if a graphics memory block whose graphics memory capacity is not less than the graphics memory capacity need of the GPU instruction to which a graphics memory is to be allocated exists in the graphics memory block 3, the graphics memory block 5 and the graphics memory block 7, a graphics memory block whose graphics memory capacity is closest to and not less than the graphics memory capacity need can be determined as the graphics memory block to be allocated to the GPU instruction to which a graphics memory is to be allocated. In an example, if a graphics memory block whose graphics memory capacity is not less than the graphics memory capacity need does not exist in the graphics memory block 3, the graphics memory block 5, and the graphics memory block 7, whether a graphics memory capacity obtained by unifying the graphics memory block 3, the graphics memory block 5, and the graphics memory block 7 is not less than the graphics memory capacity need can be further determined. If yes, graphics memory blocks whose graphics memory capacity obtained through unifying is closest to and not less than the graphics memory capacity need are determined as the graphics memory block to be allocated to the GPU instruction to which a graphics memory is to be allocated.

If the graphics memory capacity obtained through unifying is less than the graphics memory capacity need, a conditional to-be-reused graphics memory block to be allocated for the GPU instruction to which a graphics memory is to be allocated can be determined based on the first candidate graphics memory block and a to-be-reused graphics memory block. The to-be-reused graphics memory block is a graphics memory block (for example, the graphics memory block 1, the graphics memory block 2, the graphics memory block 4, and the graphics memory block 6) that is selected from the candidate reusable graphics memory block and that has a reusable state flag indicating that the graphics memory block is currently in a non-reusable state. The conditional to-be-reused graphics memory block is used to indicate that the conditionally to-be-reused graphics memory block is allowed to be reused when a reusable state flag of the to-be-reused graphics memory block is converted to indicate that the to-be-reused graphics memory block is currently in a reusable state. In an example, the conditional to-be-reused graphics memory block can be selected based on a capacity best match principle or a wait time minimum principle. In an example, the conditional to-be-reused graphics memory block can include the graphics memory block 5 and the graphics memory block 6, and is allowed to be reused only when a reusable state flag of the graphics memory block 6 changes from indicating that the graphics memory block 6 is currently in a non-reusable state to indicating that the graphics memory block 6 is currently in a reusable state.

In the above-mentioned manner, a currently allowed graphics memory block can be preferentially reused, so that a waiting time of a synchronization point can be reduced, and a task execution speed can be improved.

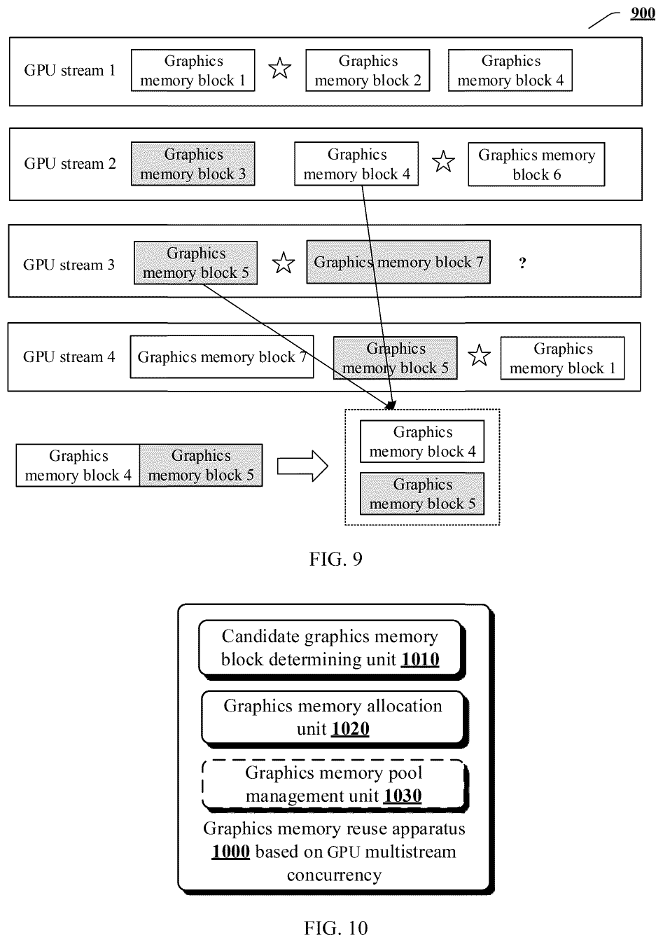

FIG. 9 is a schematic diagram illustrating an example of a graphics memory allocation process 900, according to one or more embodiments of this specification.

For descriptions of released memories respectively corresponding to all GPU streams and a reusable state flag of each graphics memory block in a graphics memory pool, references can be made to the above-mentioned descriptions. Details are omitted here for simplicity.

As shown in FIG. 9, it is assumed that a candidate reusable graphics memory block is a graphics memory block 1 to a graphics memory block 7. A second candidate graphics memory block matching a graphics memory capacity need of a GPU instruction to which a graphics memory is to be allocated can be determined from the graphics memory block 1 to the graphics memory block 7. In an example, if a graphics memory block whose graphics memory capacity is not less than the graphics memory capacity need in the graphics memory block 1 to the graphics memory block 7, a graphics memory block whose graphics memory capacity is closest to and not less than the graphics memory capacity need can be determined the second candidate graphics memory block. If a graphics memory block whose graphics memory capacity is not less than the graphics memory capacity need does not exist in the graphics memory block 1 to the graphics memory block 7, whether a graphics memory capacity obtained by unifying the graphics memory block 1 to the graphics memory block 7 is less than the graphics memory capacity need can be further determined. If yes, graphics memory blocks whose graphics memory capacity obtained through unifying is closest to and not less than the graphics memory capacity need are determined as second candidate graphics memory blocks (for example, a graphics memory block 4 and a graphics memory block 5). If the graphics memory capacity obtained through unifying is less than the graphics memory capacity need, a graphics memory allocation function in an underlying hardware driver can be invoked to allocate a new graphics memory block (namely, a graphics memory that is not in the graphics memory pool) based on the graphics memory capacity need of the GPU instruction to which a graphics memory is to be allocated. For example, a graphics memory allocation interface of the CUDA can be invoked to allocate a new graphics memory resource.

If reusable state flags of all determined second candidate graphics memory blocks indicate that the second candidate graphics memory blocks are currently in a reusable state, all the determined second candidate graphics memory block can be determined as a graphics memory block to be allocated to the GPU instruction to which a graphics memory is to be allocated. If there is a second candidate graphics memory block (for example, the graphics memory block 4) that has a reusable state flag indicating that the second candidate graphics memory block is currently in a non-reusable state, the conditional to-be-reused graphics memory block to be allocated to the GPU instruction to which a graphics memory is to be allocated can be determined based on the determined second candidate graphics memory block. For related descriptions of the conditional to-be-reused graphics memory block, references can be made to the above-mentioned descriptions. In an example, the conditional to-be-reused graphics memory block can include the graphics memory block 4 and the graphics memory block 5, and is allowed to be reused only when a reusable state flag of the graphics memory block 5 changes from indicating that the graphics memory block 5 is currently in a non-reusable state to indicating that the graphics memory block 5 is currently in a reusable state. A graphics memory block to be allocated to the GPU instruction to which a graphics memory is to be allocated can be further determined based on a candidate reusable graphics memory block having a reusable state flag indicating that the candidate reusable graphics memory block is currently in a reusable state. In some examples, a graphics memory block whose graphics memory capacity is closest to and not less than the graphics memory capacity need can be selected, from the candidate reusable graphics memory block having the reusable state flag indicating that the candidate reusable graphics memory block is currently in a reusable state, as the graphics memory block to be allocated to the GPU instruction to which a graphics memory is to be allocated. The graphics memory capacity can be a graphics memory capacity of a single graphics memory block, or can be a graphics memory capacity obtained by unifying at least two graphics memory blocks. This is not limited here.

In the above-mentioned manner, a graphics memory resource with a most matched capacity can be preferentially reused, so that generation of graphics memory fragments can be reduced as much as possible, and utilization efficiency of the graphics memory resources can be improved.

In some implementations, if a determination of 410 is no, a graphics memory allocation function in an underlying hardware driver can be invoked to allocate a new graphics memory block (namely, a graphics memory that is not in the graphics memory pool) based on the graphics memory capacity need of the GPU instruction to a graphics memory is to be allocated. For example, a graphics memory allocation interface of the CUDA can be invoked to allocate a new graphics memory resource.

In some implementations, the released graphics memory block in the graphics memory pool can be further updated based on the graphics memory block to be allocated to the GPU instruction to which a graphics memory is to be allocated. In these implementations, when the graphics memory block to be allocated to the GPU instruction to which a graphics memory is to be allocated is a reused graphics memory block determined from the graphics memory pool, the reused graphics memory block can be deleted from the graphics memory pool, so that all the graphics memory blocks existing in the graphics memory pool are released graphics memory resources.

According to the graphics memory reuse method based on GPU multistream concurrency disclosed in FIG. 1 to FIG. 9, for different stream reuse modes, the released graphics memory corresponding to the GPU stream including the GPU instruction to which a graphics memory is to be allocated, the graphics memory capacity need of the GPU instruction to which a graphics memory is to be allocated, the released memories respectively corresponding to all GPU streams, whether the current GPU stream is a default stream, etc. can be organically combined to determine whether a graphics memory block in a graphics memory pool can be reused, thereby providing a secure and efficient graphics memory reuse method.

FIG. 10 is a block diagram illustrating an example of a graphics memory reuse apparatus 1000 based on GPU multistream concurrency, according to one or more embodiments of this specification. This apparatus embodiment can correspond to the method embodiments shown in FIG. 2 to FIG. 9, and the apparatus can be specifically applied to various electronic devices.

As shown in FIG. 10, the graphics memory reuse apparatus 1000 based on a plurality of GPU concurrent streams can include a candidate graphics memory block determining unit 1010 and a graphics memory allocation unit 1020. At least two GPU streams are concurrently executed, and each GPU stream includes GPU instructions arranged in an execution sequence.

The candidate graphics memory block determining unit 1010 is configured to: in a default stream reuse mode, determine, based on a released graphics memory corresponding to a current GPU stream including a GPU instruction to which a graphics memory is to be allocated and whether the current GPU stream is a default stream, whether a candidate reusable graphics memory block exists in a graphics memory pool used to store a released graphics memory block. For an operation of the candidate graphics memory block determining unit 1010, references can be made to the operation in 410 described in FIG. 4.

In some examples, the candidate graphics memory block determining unit 1010 is further configured to: if the released graphics memory corresponding to the current GPU stream does not satisfy a graphics memory capacity need of the GPU instruction to which a graphics memory is to be allocated, and the current GPU stream is a default stream, determine that no candidate reusable graphics memory block exists in the graphics memory pool.

In some examples, the candidate graphics memory block determining unit 1010 is further configured to: if the released graphics memory corresponding to the current GPU stream does not satisfy a graphics memory capacity need of the GPU instruction to which a graphics memory is to be allocated, and the current GPU stream is not a default stream, determine, based on whether a graphics memory capacity indicated by the released graphics memory corresponding to the current GPU stream and a released graphics memory corresponding to the default stream satisfies the graphics memory capacity need, whether a candidate reusable graphics memory block exists in the graphics memory pool.

In some examples, the candidate graphics memory block determining unit 1010 is further configured to: in a multi-stream mutual reuse mode, determine, based on whether a graphics memory capacity indicated by released graphics memories respectively corresponding to all concurrently executed GPU streams satisfies a graphics memory capacity need of the GPU instruction to which a graphics memory is to be allocated, whether a candidate reusable graphics memory block exists in the graphics memory pool.

In some examples, the multi-stream mutual reuse mode is determined based on a distribution of allocated graphics memories respectively corresponding to all the concurrently executed GPU streams.

In some examples, the candidate graphics memory block determining unit 1010 is further configured to: in a source reuse mode, determine, based on whether a graphics memory capacity indicated by the released graphics memory corresponding to the current GPU stream including the GPU instruction to which a graphics memory is to be allocated satisfies a graphics memory capacity need of the GPU instruction to which a graphics memory is to be allocated, whether a candidate reusable graphics memory block exists in the graphics memory pool.

The graphics memory allocation unit 1020 is configured to: if the candidate reusable graphics memory block exists, determine, from the candidate reusable graphics memory block, a graphics memory block to be allocated to the GPU instruction to which a graphics memory is to be allocated. For an operation of the graphics memory allocation unit 1020, references can be made to the operation in 420 described in FIG. 4.

In an example, each released graphics memory block in the graphics memory pool has a reusable state flag, and the graphics memory allocation unit 1020 can be further configured to: determining, from the candidate reusable graphics memory block, a first candidate graphics memory block having a reusable state flag indicating that the first candidate graphics memory block is currently in a reusable state; determine whether the first candidate graphics memory block satisfies a graphics memory capacity need of the GPU instruction to which a graphics memory is to be allocated; if the first candidate graphics memory block satisfies the graphics memory capacity need, determine, from the first candidate graphics memory block, a graphics memory block to be allocated to the GPU instruction to which a graphics memory is to be allocated; and if the first candidate graphics memory block does not satisfy the graphics memory capacity need, determine, based on the first candidate graphics memory block and a to-be-reused graphics memory block, a conditionally to-be-reused graphics memory block to be allocated to the GPU instruction to which a graphics memory is to be allocated. The to-be-reused graphics memory block is a graphics memory block that is selected from the candidate reusable graphics memory block and that has a reusable state flag indicating that the to-be-reused graphics memory block is currently in a non-reusable state, and the conditionally to-be-reused graphics memory block is used to indicate that the conditionally to-be-reused graphics memory block is allowed to be reused when the reusable state flag of the to-be-reused graphics memory block is converted to indicate that the to-be-reused graphics memory block is currently in a reusable state.

In an example, each released graphics memory block in the graphics memory pool has a reusable state flag, and the graphics memory allocation unit 1020 may be further configured to: determine, from the candidate reusable graphics memory block, a second candidate graphics memory block matching a graphics memory capacity need of the GPU instruction to which a graphics memory is to be allocated; determine whether reusable state flags of all determined second candidate graphics memory blocks indicate that the second candidate graphics memory blocks are currently in a reusable state; if the reusable state flags of all the determined second candidate graphics memory blocks indicate that the second candidate graphics memory blocks are currently in a reusable state, determine the determined second candidate graphics memory block as a graphics memory block to be allocated to the GPU instruction to which a graphics memory is to be allocated; and if there is a second candidate graphics memory block that has a reusable state flag indicating that the second candidate graphics memory block is currently in a non-reusable state, determine, based on the determined second candidate graphics memory block, a conditional to-be-reused graphics memory block to be allocated to the GPU instruction to which a graphics memory is to be allocated, where the conditional to-be-reused graphics memory block is used to indicate that the conditionally to-be-reused graphics memory block is allowed to be reused when the reusable state flag of the to-be-reused graphics memory block is converted to indicate that the to-be-reused graphics memory block is currently in a reusable state, and the to-be-reused graphics memory block is a graphics memory block having a reusable state flag indicating that the graphics memory block is currently in a non-reusable state in the second candidate graphics memory block; or determine, based on a candidate reusable graphics memory block having a reusable state flag indicating that the candidate reusable graphics memory block is currently in a reusable state, a graphics memory block to be allocated to the GPU instruction to which a graphics memory is to be allocated.

In some examples, the graphics memory reuse apparatus 1000 can further include: a graphics memory pool management unit 1030, configured to update the released graphics memory block in the graphics memory pool based on the graphics memory block to be allocated to the GPU instruction to which a graphics memory is to be allocated.

It is worthwhile to note that for operations of the candidate graphics memory block determining unit 1010, the graphics memory allocation unit 1020, and the graphics memory pool management unit 1030, references can be made to corresponding descriptions in the above-mentioned method embodiments. Details are omitted here for simplicity.

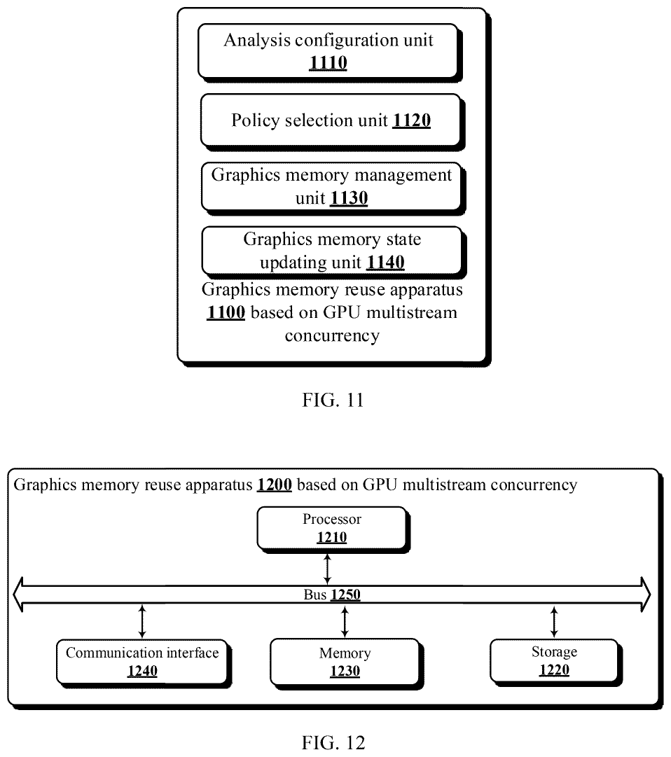

FIG. 11 is a block diagram illustrating another example of a graphics memory reuse apparatus 1100 based on GPU multistream concurrency, according to one or more embodiments of this specification.

As shown in FIG. 11, the graphics memory reuse apparatus 1100 based on GPU multistream concurrency can include: an analysis configuration unit 1110, configured to determine a current stream reuse mode; a policy selection unit 1120, configured to: determine a corresponding graphics memory reuse policy based on the current stream reuse mode; and determine, based on the determined graphics memory reuse policy, a graphics memory block to be allocated to a GPU instruction to which a graphics memory is to be allocated; a graphics memory management unit 1130, configured to perform a graphics memory allocation or graphics memory release operation; and a graphics memory state updating unit 1140, configured to update a state of a graphics memory block after the graphics memory block is allocated or released.

It is worthwhile to note that for operations of the analysis configuration unit 1110, the policy selection unit 1120, the graphics memory management unit 1130, and the graphics memory state updating unit 1140, references can be made to corresponding descriptions in the above-mentioned method embodiments. Details are omitted here for simplicity.

The embodiments of the graphics memory reuse methods and apparatuses based on GPU multistream concurrency according to the embodiments of this specification are described above with reference to FIG. 1 to FIG. 11.

The graphics memory reuse apparatus based on GPU multistream concurrency in the embodiments of this specification can be implemented by using hardware, or can be implemented by using software or a combination of hardware and software. Software implementation is used as an example. As a logical apparatus, the apparatus is formed by reading corresponding computer program instructions in a storage to a memory by a processor of a device in which the apparatus is located. In the embodiments of this specification, for example, the graphics memory reuse apparatus based on GPU multistream concurrency can be implemented by using an electronic device.

FIG. 12 is a schematic diagram illustrating an example of a graphics memory reuse apparatus 1200 based on GPU multistream concurrency, according to one or more embodiments of this specification.

As shown in FIG. 12, the graphics memory reuse apparatus 1200 based on GPU multistream concurrency can include at least one processor 1210, a storage (for example, a nonvolatile memory) 1220, a memory 1230, and a communication interface 1240, and the at least one processor 1210, the storage 1220, the memory 1230, and the communication interface 1240 are connected together through a bus 1250. The at least one processor 1210 executes at least one computer-readable instruction (namely, the above-mentioned elements implemented in a software form) stored or encoded in the storage.

In one or more embodiments, the storage stores computer-executable instructions, and when the computer-executable instructions are executed, the at least one processor 1210 is enabled to perform the following operations: in a default stream reuse mode, determining, based on a released graphics memory corresponding to a current GPU stream including a GPU instruction to which a graphics memory is to be allocated and whether the current GPU stream is a default stream, whether a candidate reusable graphics memory block exists in a graphics memory pool used to store a released graphics memory block, where at least two GPU streams are concurrently executed, and each GPU stream includes GPU instructions arranged in an execution sequence; and if the candidate reusable graphics memory block exists, determining, from the candidate reusable graphics memory block, a graphics memory block to be allocated to the GPU instruction to which a graphics memory is to be allocated.

It should be understood that, when the computer-executable instructions stored in the storage are executed, the at least one processor 1210 is enabled to perform the above-mentioned operations and functions described with reference to FIG. 1 to FIG. 9 in the embodiments of this specification.

According to one or more embodiments, a program product such as a computer-readable medium is provided. The computer-readable medium can have instructions (to be specific, the above-mentioned element implemented in a software form). When the instructions are executed by a computer, the computer is enabled to perform the above-mentioned operations and functions described with reference to FIG. 1 to FIG. 9 in the embodiments of this specification.

Specifically, a system or an apparatus equipped with a readable storage medium can be provided, and software program code for implementing the functions in any of the above-mentioned embodiments is stored in the readable storage medium, so that a computer or a processor of the system or the apparatus reads and executes the instructions stored in the readable storage medium.

In this case, the program code read from the readable medium can implement the functions in any one of the embodiments described above, and therefore the machine-readable code and the readable storage medium storing the machine-readable code form a part of this specification.

Computer program code needed for operation of each part of this specification can be compiled in any one or more programming languages, including an object-oriented programming language such as Java, Scala, Smalltalk, Eiffel, JADE, Emerald, C++, C#, VB, NET, and Python, a conventional programming language such as C language, Visual Basic 2003, Perl, COBOL 2002, PHP, and ABAP, a dynamic programming language such as Python, Ruby, and Groovy, or another programming language. The program code can run on a user computer, or run as a stand-alone package on the user computer, or partially run on the user computer and partially run on a remote computer, or run on the remote computer or server as a whole. In the latter case, the remote computer can be connected to the user computer in any form of network, such as a local area network (LAN) or a wide area network (WAN), or connected to an external computer (for example, via the Internet), or in a cloud computing environment, or used as a service, such as software as a service (SaaS).

Embodiments of the readable storage medium include a floppy disk, a hard disk, a magneto-optical disk, an optical disc (such as a CD-ROM, a CD-R, a CD-RW, a DVD-ROM, a DVD-RAM, and a DVD-RW), a magnetic tape, a non-volatile memory card, and a ROM. Alternatively, the program code can be downloaded from a server computer or a cloud over a communication network.

Specific embodiments of this specification are described above. Other embodiments fall within the scope of the appended claims. In some cases, the actions or steps described in the claims can be performed in an order different from that in the embodiments, and the desired results can still be achieved. In addition, the process depicted in the accompanying drawings does not necessarily need a particular sequence or consecutive sequence to achieve the desired results. In some implementations, multi-tasking and parallel processing are feasible or may be advantageous.

Not all steps and units in the above-mentioned processes and system structure diagrams are needed. Some steps or units can be ignored based on actual needs. An execution sequence of each step is not fixed, and can be determined based on needs. The apparatus structure described in some embodiments can be a physical structure or a logical structure. In other words, some units can be implemented by the same physical entity, or some units can be implemented by a plurality of physical entities, or can be implemented together by some components in a plurality of independent devices.

The term “example” used throughout this specification means “used as an example, an instance, or an illustration” and does not mean “preferred” or “advantageous” over other embodiments. Specific implementations include specific details for the purpose of providing an understanding of the described technologies. However, these technologies can be implemented without these specific details. In some examples, well-known structures and apparatuses are shown in block diagrams, to avoid making it difficult to understand the concepts of the described embodiments.

Optional implementations of the embodiments of this specification are described above with reference to the accompanying drawings. However, the embodiments of this specification are not limited to specific details in the above-mentioned implementations. Within a technical concept scope of the embodiments of this specification, multiple simple variations of the technical solutions of the embodiments of this specification can be made, and these simple variations are all within the protection scope of the embodiments of this specification.

The above-mentioned descriptions of content in this specification are provided to enable any person of ordinary skill in the art to implement or use content in this specification. It is obvious to a person of ordinary skill in the art that various modifications can be made to content in this specification. In addition, the general principle defined in this specification can be applied to another variant without departing from the protection scope of the content in this specification. Therefore, the content in this specification is not limited to the examples and designs described here, but is consistent with the widest range of principles and novelty features that conform to the disclosure.

1. A graphics memory reuse method based on GPU multistream concurrency, the method comprises:
in a default stream reuse mode, determining, based on (1) a released graphics memory corresponding to a current GPU stream that comprises a GPU instruction to which a graphics memory is to be allocated, and (2) whether the current GPU stream is a default stream, whether a candidate reusable graphics memory block exists in a graphics memory pool for storing a released graphics memory block, wherein the current GPU stream is one of at least two concurrently executed GPU streams, and wherein each of the at least two currently executed GPU streams comprises GPU instructions arranged in an execution sequence; and
if the candidate reusable graphics memory block exists, determining, from the candidate reusable graphics memory block, a graphics memory block to be allocated to the GPU instruction.

2. The graphics memory reuse method according to claim 1, wherein determining whether the candidate reusable graphics memory block exists in the graphics memory pool comprises:
if the released graphics memory corresponding to the current GPU stream does not satisfy a graphics memory capacity need of the GPU instruction, and the current GPU stream is a default stream, determining that no candidate reusable graphics memory block exists in the graphics memory pool.

3. The graphics memory reuse method according to claim 1, wherein determining whether the candidate reusable graphics memory block exists in the graphics memory pool comprises:
if the released graphics memory corresponding to the current GPU stream does not satisfy a graphics memory capacity need of the GPU instruction, and the current GPU stream is not a default stream, determining, based on whether a graphics memory capacity indicated by the released graphics memory corresponding to the current GPU stream and a released graphics memory corresponding to the default stream satisfies the graphics memory capacity need, whether a candidate reusable graphics memory block exists in the graphics memory pool.

4. The graphics memory reuse method according to claim 1, wherein the method further comprises:
in a multi-stream mutual reuse mode, determining, based on whether a graphics memory capacity indicated by released graphics memories respectively corresponding to the at least two concurrently executed GPU streams satisfies a graphics memory capacity need of the GPU instruction, whether a candidate reusable graphics memory block exists in the graphics memory pool.

5. The graphics memory reuse method according to claim 4, wherein the multi-stream mutual reuse mode is determined based on a distribution of allocated graphics memories respectively corresponding to the at least two concurrently executed GPU streams.

6. The graphics memory reuse method according to claim 1, wherein the method further comprises:
in a source reuse mode, determining, based on whether a graphics memory capacity indicated by the released graphics memory corresponding to the current GPU stream comprising the GPU instruction satisfies a graphics memory capacity need of the GPU instruction, whether a candidate reusable graphics memory block exists in the graphics memory pool.

7. The graphics memory reuse method according to claim 1, wherein each released graphics memory block in the graphics memory pool has a reusable state flag; and
the determining, from the candidate reusable graphics memory block, a graphics memory block to be allocated to the GPU instruction comprises:
determining, from the candidate reusable graphics memory block, a first candidate graphics memory block having a reusable state flag indicating that the first candidate graphics memory block is currently in a reusable state;
determining whether the first candidate graphics memory block satisfies a graphics memory capacity need of the GPU instruction;
if the first candidate graphics memory block satisfies the graphics memory capacity need, determining, from the first candidate graphics memory block, a graphics memory block to be allocated to the GPU instruction; and
if the first candidate graphics memory block does not satisfy the graphics memory capacity need, determining, based on the first candidate graphics memory block and a to-be-reused graphics memory block, a conditionally to-be-reused graphics memory block to be allocated to the GPU instruction, wherein the to-be-reused graphics memory block is a graphics memory block selected from the candidate reusable graphics memory block and has a reusable state flag indicating that the to-be-reused graphics memory block is currently in a non-reusable state, and the conditionally to-be-reused graphics memory block indicates that the conditionally to-be-reused graphics memory block is allowed to be reused when the reusable state flag of the to-be-reused graphics memory block is converted to indicate that the to-be-reused graphics memory block is currently in a reusable state.

8. The graphics memory reuse method according to claim 1, wherein each released graphics memory block in the graphics memory pool has a reusable state flag; and
the determining, from the candidate reusable graphics memory block, a graphics memory block to be allocated to the GPU instruction comprises:
determining, from the candidate reusable graphics memory block, a second candidate graphics memory block matching a graphics memory capacity need of the GPU instruction;
determining whether reusable state flags of determined second candidate graphics memory blocks indicate that the second candidate graphics memory blocks are currently in a reusable state;
if the reusable state flags of the determined second candidate graphics memory blocks indicate that the second candidate graphics memory blocks are currently in a reusable state, determining the determined second candidate graphics memory block as a graphics memory block to be allocated to the GPU instruction; and
if a second candidate graphics memory block having a reusable state flag indicating that the second candidate graphics memory block is currently in a non-reusable state,
determining, based on the determined second candidate graphics memory block, a conditional to-be-reused graphics memory block to be allocated to the GPU instruction, wherein the conditional to-be-reused graphics memory block indicates that the conditionally to-be-reused graphics memory block is allowed to be reused when the reusable state flag of the to-be-reused graphics memory block is converted to indicate that the to-be-reused graphics memory block is currently in a reusable state, and the to-be-reused graphics memory block is a graphics memory block having a reusable state flag indicating that the graphics memory block is currently in a non-reusable state in the second candidate graphics memory block; or
determining, based on a candidate reusable graphics memory block having a reusable state flag indicating that the candidate reusable graphics memory block is currently in a reusable state, a graphics memory block to be allocated to the GPU instruction.

9. The graphics memory reuse method according to claim 1, wherein after the determining, from the candidate reusable graphics memory block, a graphics memory block to be allocated to the GPU instruction, the graphics memory reuse method further comprises:
updating the released graphics memory block in the graphics memory pool based on the graphics memory block to be allocated to the GPU instruction.

10. A graphics memory reuse apparatus for graphics memory reuse based on GPU multistream concurrency, the apparatus comprises:
at least one processor; and
one or more memories coupled to the at least one processor and storing programming instructions for execution by the at least one processor to perform operations comprising:
in a default stream reuse mode, determining, based on (1) a released graphics memory corresponding to a current GPU stream that comprises a GPU instruction to which a graphics memory is to be allocated, and (2) whether the current GPU stream is a default stream, whether a candidate reusable graphics memory block exists in a graphics memory pool for storing a released graphics memory block, wherein the current GPU stream is one of at least two concurrently executed GPU streams, and wherein each of the at least two currently executed GPU streams comprises GPU instructions arranged in an execution sequence; and
if the candidate reusable graphics memory block exists, determining, from the candidate reusable graphics memory block, a graphics memory block to be allocated to the GPU instruction.

11. The graphics memory reuse apparatus according to claim 10, wherein the operations further comprise:
if the released graphics memory corresponding to the current GPU stream does not satisfy a graphics memory capacity need of the GPU instruction, and the current GPU stream is not a default stream, determining, based on whether a graphics memory capacity indicated by the released graphics memory corresponding to the current GPU stream and a released graphics memory corresponding to the default stream satisfies the graphics memory capacity need, whether a candidate reusable graphics memory block exists in the graphics memory pool.

12. The graphics memory reuse apparatus according to claim 10, wherein the operations further comprise:
in a multi-stream mutual reuse mode, determining, based on whether a graphics memory capacity indicated by released graphics memories respectively corresponding to the at least two concurrently executed GPU streams satisfies a graphics memory capacity need of the GPU instruction, whether a candidate reusable graphics memory block exists in the graphics memory pool.

13. The graphics memory reuse apparatus according to claim 10, wherein each released graphics memory block in the graphics memory pool has a reusable state flag; and
the determining, from the candidate reusable graphics memory block, a graphics memory block to be allocated to the GPU instruction comprises:
determining, from the candidate reusable graphics memory block, a first candidate graphics memory block having a reusable state flag indicating that the first candidate graphics memory block is currently in a reusable state;
determining whether the first candidate graphics memory block satisfies a graphics memory capacity need of the GPU instruction;
if the first candidate graphics memory block satisfies the graphics memory capacity need, determining, from the first candidate graphics memory block, a graphics memory block to be allocated to the GPU instruction; and
if the first candidate graphics memory block does not satisfy the graphics memory capacity need, determining, based on the first candidate graphics memory block and a to-be-reused graphics memory block, a conditionally to-be-reused graphics memory block to be allocated to the GPU instruction, wherein the to-be-reused graphics memory block is a graphics memory block selected from the candidate reusable graphics memory block and has a reusable state flag indicating that the to-be-reused graphics memory block is currently in a non-reusable state, and the conditionally to-be-reused graphics memory block indicates that the conditionally to-be-reused graphics memory block is allowed to be reused when the reusable state flag of the to-be-reused graphics memory block is converted to indicate that the to-be-reused graphics memory block is currently in a reusable state.

14. The graphics memory reuse apparatus according to claim 10, wherein each released graphics memory block in the graphics memory pool has a reusable state flag; and
the determining, from the candidate reusable graphics memory block, a graphics memory block to be allocated to the GPU instruction comprises:
determining, from the candidate reusable graphics memory block, a second candidate graphics memory block matching a graphics memory capacity need of the GPU instruction;
determining whether reusable state flags of determined second candidate graphics memory blocks indicate that the second candidate graphics memory blocks are currently in a reusable state;
if the reusable state flags of the determined second candidate graphics memory blocks indicate that the second candidate graphics memory blocks are currently in a reusable state, determining the determined second candidate graphics memory block as a graphics memory block to be allocated to the GPU instruction; and
if a second candidate graphics memory block having a reusable state flag indicating that the second candidate graphics memory block is currently in a non-reusable state,
determining, based on the determined second candidate graphics memory block, a conditional to-be-reused graphics memory block to be allocated to the GPU instruction, wherein the conditional to-be-reused graphics memory block indicates that the conditionally to-be-reused graphics memory block is allowed to be reused when the reusable state flag of the to-be-reused graphics memory block is converted to indicate that the to-be-reused graphics memory block is currently in a reusable state, and the to-be-reused graphics memory block is a graphics memory block having a reusable state flag indicating that the graphics memory block is currently in a non-reusable state in the second candidate graphics memory block; or
determining, based on a candidate reusable graphics memory block having a reusable state flag indicating that the candidate reusable graphics memory block is currently in a reusable state, a graphics memory block to be allocated to the GPU instruction.

15. A non-transitory, computer-readable medium storing one or more instructions executable by at least one processor to cause an apparatus for graphics memory reuse based on GPU multistream concurrency to perform operations comprising:
in a default stream reuse mode, determining, based on (1) a released graphics memory corresponding to a current GPU stream that comprises a GPU instruction to which a graphics memory is to be allocated, and (2) whether the current GPU stream is a default stream, whether a candidate reusable graphics memory block exists in a graphics memory pool for storing a released graphics memory block, wherein the current GPU stream is one of at least two concurrently executed GPU streams, and wherein each of the at least two currently executed GPU streams comprises GPU instructions arranged in an execution sequence; and
if the candidate reusable graphics memory block exists, determining, from the candidate reusable graphics memory block, a graphics memory block to be allocated to the GPU instruction.

16. The non-transitory, computer-readable medium according to claim 15, wherein the operations further comprise:
if the released graphics memory corresponding to the current GPU stream does not satisfy a graphics memory capacity need of the GPU instruction, and the current GPU stream is not a default stream, determining, based on whether a graphics memory capacity indicated by the released graphics memory corresponding to the current GPU stream and a released graphics memory corresponding to the default stream satisfies the graphics memory capacity need, whether a candidate reusable graphics memory block exists in the graphics memory pool.

17. The non-transitory, computer-readable medium according to claim 15, wherein the operations further comprise:
in a multi-stream mutual reuse mode, determining, based on whether a graphics memory capacity indicated by released graphics memories respectively corresponding to the at least two concurrently executed GPU streams satisfies a graphics memory capacity need of the GPU instruction, whether a candidate reusable graphics memory block exists in the graphics memory pool.

18. The non-transitory, computer-readable medium according to claim 15, wherein each released graphics memory block in the graphics memory pool has a reusable state flag; and
the determining, from the candidate reusable graphics memory block, a graphics memory block to be allocated to the GPU instruction comprises:
determining, from the candidate reusable graphics memory block, a first candidate graphics memory block having a reusable state flag indicating that the first candidate graphics memory block is currently in a reusable state;
determining whether the first candidate graphics memory block satisfies a graphics memory capacity need of the GPU instruction;
if the first candidate graphics memory block satisfies the graphics memory capacity need, determining, from the first candidate graphics memory block, a graphics memory block to be allocated to the GPU instruction; and
if the first candidate graphics memory block does not satisfy the graphics memory capacity need, determining, based on the first candidate graphics memory block and a to-be-reused graphics memory block, a conditionally to-be-reused graphics memory block to be allocated to the GPU instruction, wherein the to-be-reused graphics memory block is a graphics memory block selected from the candidate reusable graphics memory block and has a reusable state flag indicating that the to-be-reused graphics memory block is currently in a non-reusable state, and the conditionally to-be-reused graphics memory block indicates that the conditionally to-be-reused graphics memory block is allowed to be reused when the reusable state flag of the to-be-reused graphics memory block is converted to indicate that the to-be-reused graphics memory block is currently in a reusable state.

19. The non-transitory, computer-readable medium according to claim 15, wherein each released graphics memory block in the graphics memory pool has a reusable state flag; and
the determining, from the candidate reusable graphics memory block, a graphics memory block to be allocated to the GPU instruction comprises:
determining, from the candidate reusable graphics memory block, a second candidate graphics memory block matching a graphics memory capacity need of the GPU instruction;
determining whether reusable state flags of determined second candidate graphics memory blocks indicate that the second candidate graphics memory blocks are currently in a reusable state;
if the reusable state flags of the determined second candidate graphics memory blocks indicate that the second candidate graphics memory blocks are currently in a reusable state, determining the determined second candidate graphics memory block as a graphics memory block to be allocated to the GPU instruction; and
if a second candidate graphics memory block having a reusable state flag indicating that the second candidate graphics memory block is currently in a non-reusable state,
determining, based on the determined second candidate graphics memory block, a conditional to-be-reused graphics memory block to be allocated to the GPU instruction, wherein the conditional to-be-reused graphics memory block indicates that the conditionally to-be-reused graphics memory block is allowed to be reused when the reusable state flag of the to-be-reused graphics memory block is converted to indicate that the to-be-reused graphics memory block is currently in a reusable state, and the to-be-reused graphics memory block is a graphics memory block having a reusable state flag indicating that the graphics memory block is currently in a non-reusable state in the second candidate graphics memory block; or
determining, based on a candidate reusable graphics memory block having a reusable state flag indicating that the candidate reusable graphics memory block is currently in a reusable state, a graphics memory block to be allocated to the GPU instruction.

20. The non-transitory, computer-readable medium according to claim 15, wherein after the determining, from the candidate reusable graphics memory block, a graphics memory block to be allocated to the GPU instruction, the operations further comprise:
updating the released graphics memory block in the graphics memory pool based on the graphics memory block to be allocated to the GPU instruction.
